(19) United States
(12) Patent Application Publication
(10) Pub. No.: US 2025/0118923 A1
(43) Pub. Date: Apr. 10, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Takeyoshi OGUMA, Osaka (JP)

(21) Appl. No.: 18/833,930

(22) PCT Filed: Dec. 21, 2022
(86) PCT No.: PCT/JP2022/047080

§ 371 Date: Jul. 29, 2024

(30) Foreign Application Priority Data
Feb. 3, 2022 (JP) 2022-015715

(51) Int. Cl. H01R 13/424; H01R 13/52

(52) U.S. Cl. CPC H01R 13/424; H01R 13/521

(57) ABSTRACT

A connector includes a housing (10) including a terminal accommodation chamber (15), a terminal fitting (30) to be inserted into the terminal accommodation chamber (15) from behind the housing (10), a locking lance (16) formed in a peripheral wall portion (11) constituting the terminal accommodation chamber (15) and configured to retain the terminal fitting (30), and an excessive deflection restricting portion (27) for keeping a deflection amount of the locking lance (16) within a certain range when the locking lance (16) is resiliently deformed in a direction separating from the terminal fitting (30). The locking lance (16) is arranged in a state exposed on an inner peripheral surface (11B) and an outer peripheral surface (11A) of the peripheral wall portion (11). The excessive deflection restricting portion (27) is arranged within a thickness range of the peripheral wall portion (11).

### TECHNICAL FIELD

The present disclosure relates to a connector.

### BACKGROUND

Patent Document 1 discloses a connector provided with a housing having a sealing ring mounted thereon and a terminal fitting to be inserted into a cavity of the housing. A peripheral wall portion constituting the cavity is formed with a resiliently deformable locking lance. The terminal fitting inserted into the cavity is retained by the locking action of the locking lance. In pulling out the terminal fitting from the cavity, the locking lance is deflected using a jig to release the locking of the terminal fitting by the locking lance. The housing is formed with a support plate facing the locking lance across a deflection allowing space for the locking lance. When the locking lance is deflected using the jig, the locking lance contacts the support plate, whereby excessive deflection of the locking lance is prevented.

### PRIOR ART DOCUMENT

### Patent Document

Patent Document 1: JP 2003-115345 A

### SUMMARY OF THE INVENTION

### Problems to be Solved

In the above connector, the support plate for restricting the excessive deflection of the locking lance is arranged to face the locking lance across the deflection allowing space and cover the peripheral wall portion. Thus, there is a problem of enlarging the entire connector.

A connector of the present disclosure was completed on the basis of the above situation and aims to achieve a size reduction.

### Means to Solve the Problem

The present disclosure is directed to a connector with a housing including a terminal accommodation chamber, a terminal fitting to be inserted into the terminal accommodation chamber from behind the housing, a locking lance formed in a peripheral wall portion constituting the terminal accommodation chamber, the locking lance retaining the terminal fitting, and an excessive deflection restricting portion for keeping a deflection amount of the locking lance within a certain range when the locking lance is resiliently deformed in a direction separating from the terminal fitting, the locking lance being arranged in a state exposed on an inner peripheral surface and an outer peripheral surface of the peripheral wall portion, and the excessive deflection restricting portion being arranged within a thickness range of the peripheral wall portion.

### Effect of the Invention

According to the present disclosure, a size reduction can be achieved.

### BRIEF DESCRIPTION OF THE DRAWINGS

FIG. 1 is a perspective view of a connector of one embodiment.

FIG. 2 is a perspective view showing a housing cut horizontally.

FIG. 3 is a front view of the housing.

FIG. 4 is a partial enlarged front view of the housing.

FIG. 5 is a partial enlarged front view showing a state where a locking lance is in contact with excessive deflection restricting portions.

FIG. 6 is a back view of the housing.

FIG. 7 is a section along X-X of FIG. 3.

FIG. 8 is a partial enlarged section along X-X of FIG. 3.

FIG. 9 is a partial enlarged section along Y-Y of FIG. 3 showing the state where the locking lance is in contact with the excessive deflection restricting portion.

### DETAILED DESCRIPTION TO EXECUTE THE INVENTION

### Description of Embodiments of Present Disclosure

First, embodiments of the present disclosure are listed and described.
(1) The connector of the present disclosure is provided with a housing including a terminal accommodation chamber, a terminal fitting to be inserted into the terminal accommodation chamber from behind the housing, a locking lance formed in a peripheral wall portion constituting the terminal accommodation chamber, the locking lance retaining the terminal fitting, and an excessive deflection restricting portion for keeping a deflection amount of the locking lance within a certain range when the locking lance is resiliently deformed in a direction separating from the terminal fitting, the locking lance being arranged in a state exposed on an inner peripheral surface and an outer peripheral surface of the peripheral wall portion, and the excessive deflection restricting portion being arranged within a thickness range of the peripheral wall portion. According to the present disclosure, since the excessive deflection restricting portion is arranged within the thickness range of the peripheral wall portion, a size reduction can be achieved as compared to the case where the excessive deflection restricting portion is arranged to cover the peripheral wall portion.
(2) Preferably, the locking lance is shaped such that a narrow portion and a wide portion having a larger width than the narrow portion are connected in a deflection direction of the locking lance, and a part of the wide portion projecting in a width direction from the narrow portion has a function as a contact portion for restricting excessive deflection of the locking lance by butting against the excessive deflection restricting portion. According to this configuration, since a region of the locking lance where the wide portion and the narrow portion are arranged has a large thickness and a high rigidity, the locking lance is excellent in the reliability of a function of retaining the terminal fitting as compared to a thin locking lance constituted only by the wide portion.
(3) Preferably, in (2), the wide portion has a function as a locking projection for retaining and locking the terminal fitting. According to this configuration, the shape of the locking lance can be simplified as compared to the case where the locking projection and the contact portion are formed as different parts.
(4) Preferably, in (2) or (3), a posture of the locking lance is inclined with a rear end of the locking lance as a fulcrum when the locking lance is resiliently deformed in the direction separating from the terminal fitting, and an interval between a front end of the contact portion and the excessive deflection restricting portion is set to be larger than an interval between a rear end of the contact portion and the excessive deflection restricting portion in a free state where the locking lance is not resiliently deformed. According to this configuration, since a large resilient deformation amount of the locking lance in the direction separating from the terminal fitting can be ensured, a locking margin of the locking lance with the terminal fitting can be increased and a holding force by the locking lance can be enhanced.
(5) Preferably, in (2) to (4), the peripheral wall portion has a hollow cylindrical shape in a front view of the locking lance, the wide portion has an arcuate shape in the front view, and the narrow portion is formed with a straight jig contact portion. According to this configuration, since the orientation and position of a jig are stabilized when the jig is hooked to the jig contact portion, an operation of resiliently deforming the locking lance is easily performed.
(6) Preferably, a sealing ring is arranged at a position separated rearward from a rear end of the locking lance on the outer peripheral surface of the peripheral wall portion. According to this configuration, a size reduction can be achieved as compared to the case where the sealing ring is arranged on the outer peripheral surface of a wall portion formed on an outer periphery side of the peripheral wall portion.

### Details of Embodiment of Present Disclosure

### Embodiment

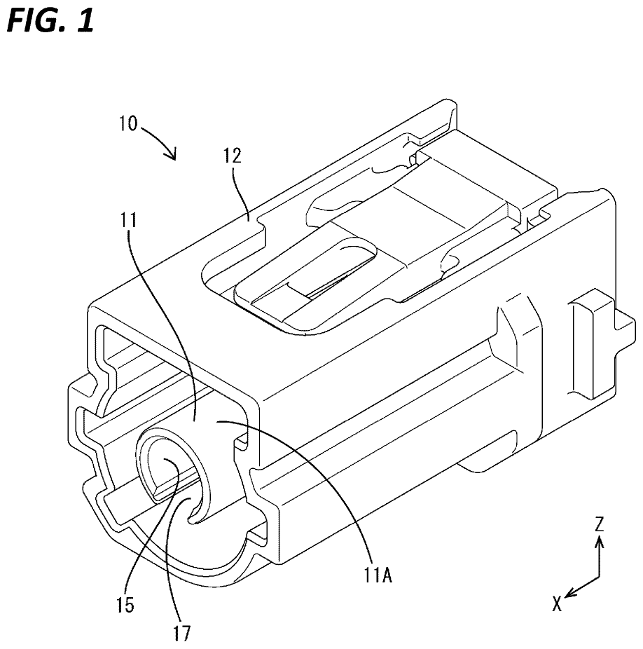

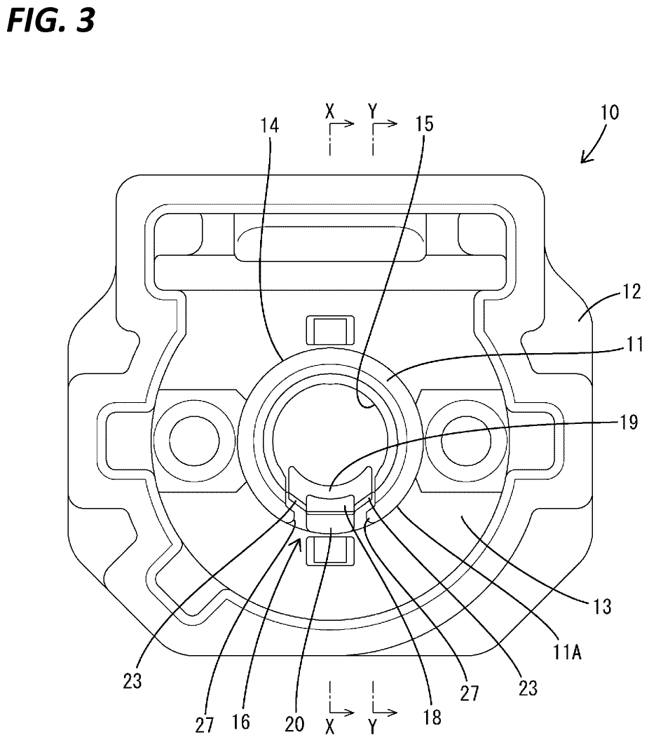

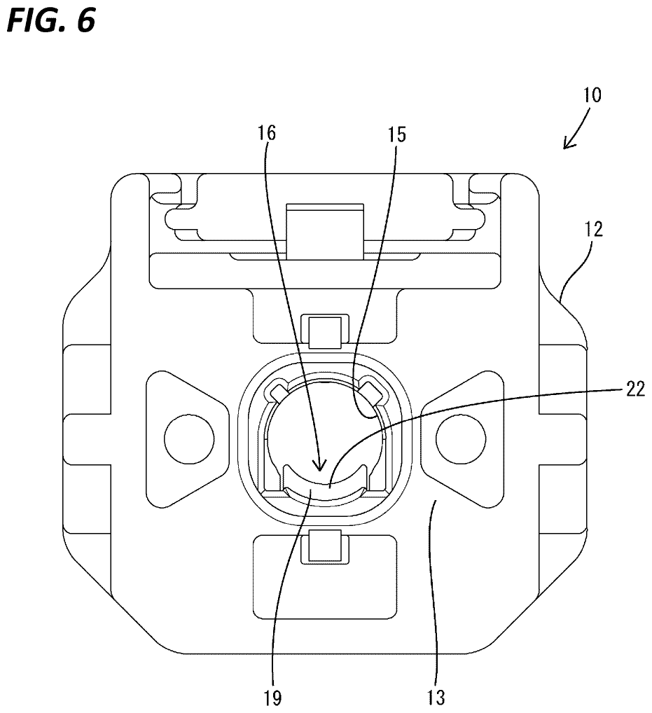

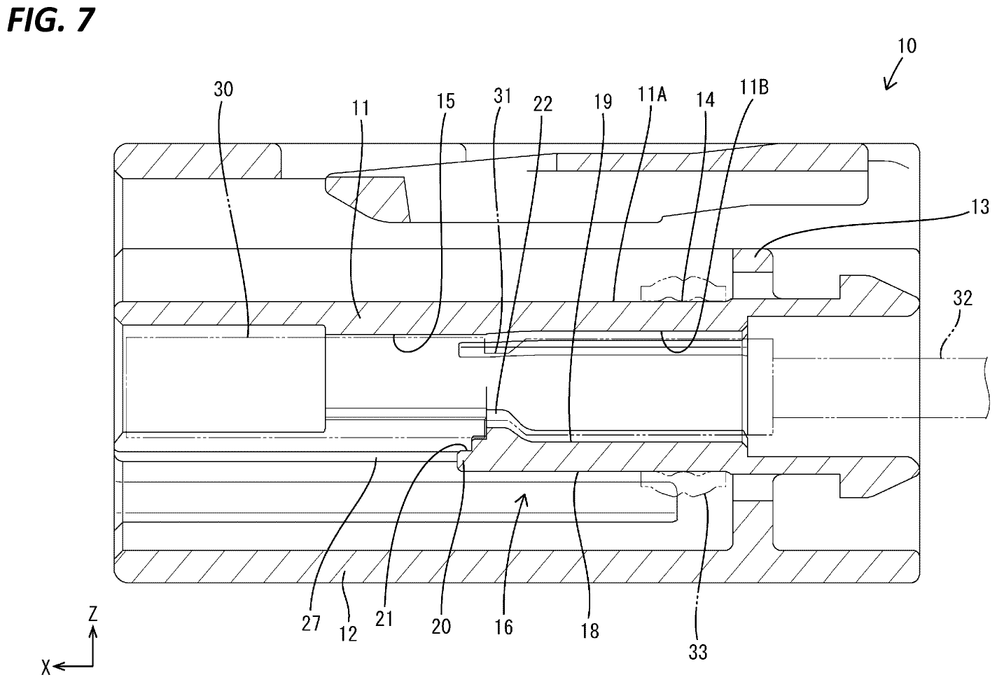

One specific embodiment of the present disclosure is described with reference to FIGS. 1 to 9. Note that the present invention is not limited to these illustrations, but is represented by claims and intended to include all changes in the scope of claims and in the meaning and scope of equivalents. In this embodiment, a positive direction of an X axis in FIGS. 1, 2 and 7 to 9 is defined as a forward direction concerning a front-rear direction. A positive direction of a Z axis in FIGS. 1, 2 and 7 to 9 is defined as an upward direction concerning a vertical direction.

A connector of this embodiment is used for high-speed communication and has a shielding function and a waterproof function. The connector is configured by assembling a housing 10, a terminal fitting 30 and a sealing ring 33.

The terminal fitting 30 functions as a shield terminal provided with an inner conductor (not shown), a dielectric (not shown) surrounding the inner conductor and an outer conductor (not shown) surrounding the dielectric. The outer conductor has a hollow cylindrical shape as a whole. In a front view of the connector, the outer shape of the terminal fitting 30, i.e. the outer peripheral shape of the outer conductor, is circular. A locking hole 31 is formed in the outer peripheral surface of the outer conductor. A rear end part of the terminal fitting 30 is connected to a front end part of a coaxial cable 32.

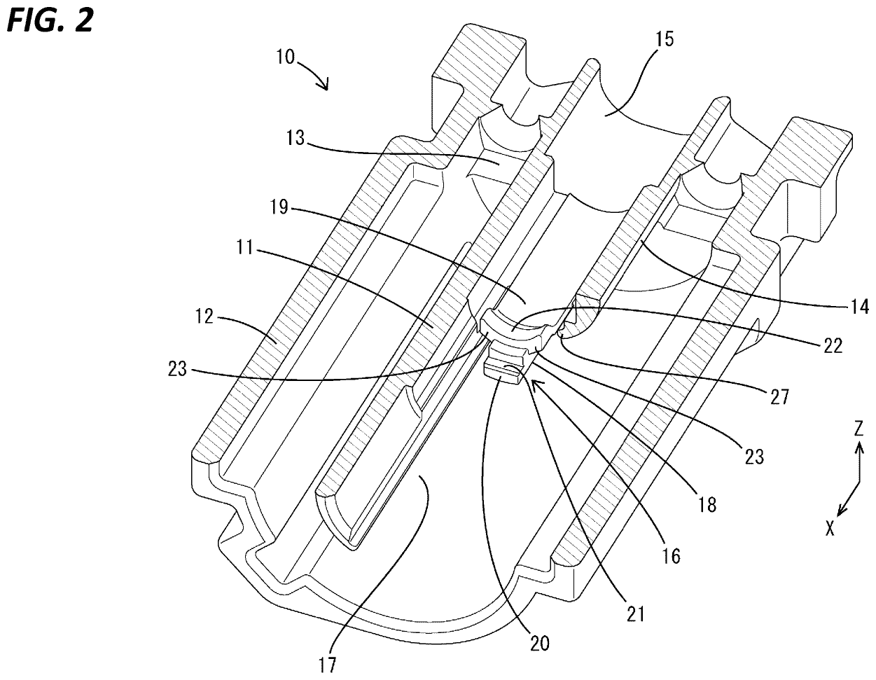

The housing 10 is a single component made of synthetic resin. As shown in FIGS. 2, 3 and 7, the housing 10 includes a hollow cylindrical peripheral wall portion 11, a tubular fitting portion 12 surrounding the peripheral wall portion 11 and a supporting portion 13. A part of an outer peripheral surface 11A of the peripheral wall portion 11 near a rear end and a part of the inner peripheral surface of the tubular fitting portion 12 near a rear end are connected via the supporting portion 13.

The outer peripheral surface 11A of the peripheral wall portion 11 is circular in a front view. Out of the outer peripheral surface 11A of the peripheral wall portion 11, a region in front of and adjacent to the supporting portion 13 has a function as a sealing surface 14. The sealing ring 33 is mounted on the sealing surface 14. A receptacle (not shown) of a mating connector (not shown) is fit into a tubular space between the peripheral wall portion 11 and the tubular fitting portion 12. With the receptacle fit, the sealing ring 33 is held in close contact with the sealing surface 14 and the inner peripheral surface of the receptacle, thereby sealing between the housing 10 and the mating connector in a liquid-tight manner.

An internal space of the peripheral wall portion 11 functions as a terminal accommodation chamber 15 for accommodating the terminal fitting 30. The terminal fitting 30 is inserted into the terminal accommodation chamber 15 from behind the housing 10. The peripheral wall portion 11 is formed with a locking lance 16 for retaining the terminal fitting 30 inserted into the terminal accommodation chamber 15. The locking lance 16 is a part constituting a part of the peripheral wall portion 11, and arranged only in a region in front of the sealing surface 14. The region of the peripheral wall portion 11 in front of the locking lance 16 is cut as a mold removal space 17 formed when the locking lance 16 is molded. A jig J for disengaging the locking lance 16 from the terminal fitting 30 is inserted into the mold removal space 17 from the front of the housing 10.

The locking lance 16 has a cantilever shape extending forward. The locking lance 16 is resiliently deformable radially outward with a rear end part of the locking lance 16 as a fulcrum. When being viewed in a circumferential direction, the locking lance 16 assumes such an oblique posture that a front end part of the locking lance moves away from the terminal accommodation chamber 15 if the locking lance 16 is resiliently deformed radially outward.

The front view shape of the locking lance 16 is symmetrical with respect to a virtual axis of symmetry (not shown) crossing a width direction of the locking lance 16 (circumferential direction concentric with the peripheral wall portion 11). The locking lance 16 includes a narrow portion 18 and a wide portion 19. The narrow portion 18 has a shape elongated in the front-rear direction and is formed over the entire length of the locking lance 16. The rear end of the narrow portion 18 is connected to the peripheral wall portion 11. An outer surface of the narrow portion 18 on a side opposite to the terminal accommodation chamber 15 is exposed on the outer peripheral surface 11A of the peripheral wall portion 11.

A stepped jig contact portion 20 is formed on the front end surface of the narrow portion 18 when the locking lance 16 is viewed in the circumferential direction. The jig contact portion 20 is shaped to project forward from a radially outer position of the front end surface of the narrow portion 18. The outer surface of the jig contact portion 20 is continuous and flush with the outer surface of the narrow portion 18 (outer surface of the locking lance 16). The inner surface of the jig contact portion 20 functions as a jig contact surface 21. When a virtual line (not shown) in a radial direction passing through a widthwise center of the jig contact portion 20 is set in a front view, the jig contact surface 21 is a flat surface perpendicular to this virtual line.

A formation range in the front-rear direction of the wide portion 19 is a region except a front end part (jig contact portion 20), out of the entire length of the locking lance 16. The rear end of the wide portion 19 is connected to the peripheral wall portion 11. A width (dimension in the circumferential direction) of the wide portion 19 is set to be larger than a width (dimension in the circumferential direction) of the narrow portion 18. The entire narrow portion 18 and a widthwise central part of the wide portion 19 are connected in the radial direction. The wide portion 19 is located radially inward of the narrow portion 18.

A front end part of the wide portion 19 is formed with one locking projection 22 and a pair of contact portions 23. The locking projection 22 projects radially inward from the inner surface of the wide portion 19, i.e. into the terminal accommodation chamber 15. The locking projection 22 is formed over the entire region in the width direction of the wide portion 19. The inner surface of the locking projection 22 has an arcuate front view shape concentric with the outer peripheral surface 11A of the peripheral wall portion 11 and having a smaller radius of curvature than the outer peripheral surface 11A of the peripheral wall portion 11. A region behind the locking projection 22, out of the inner surface (surface facing the terminal accommodation chamber 15) of the wide portion 19, is exposed on an inner peripheral surface 11B of the peripheral wall portion 11 and facing the inside of the terminal accommodation chamber 15.

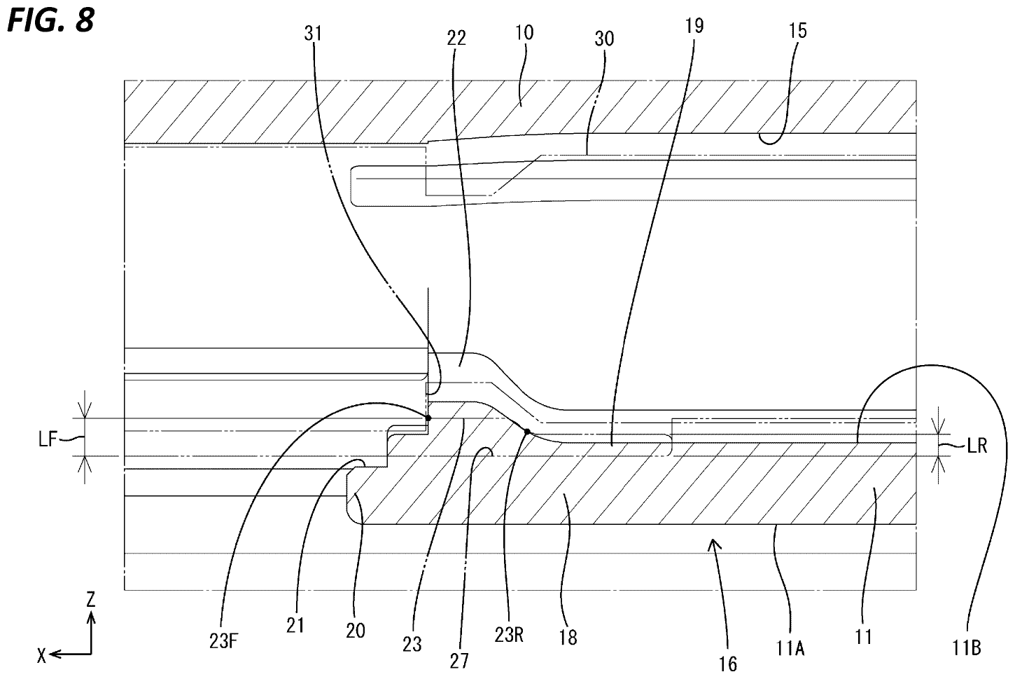

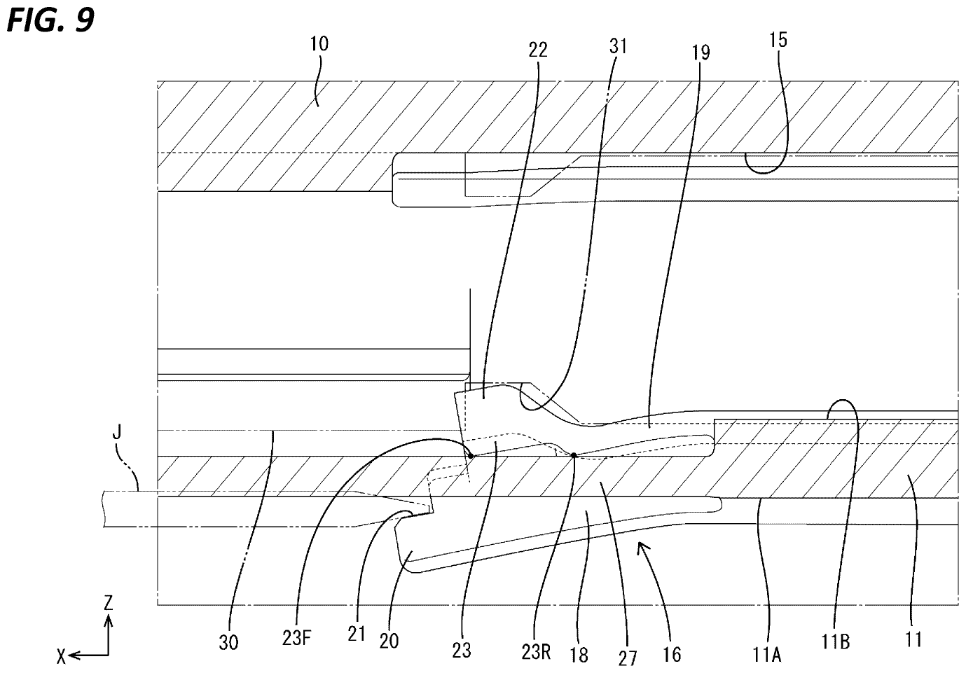

The pair of contact portions 23 protrude more outward in the width direction than widthwise outer side surfaces of the narrow portion 18 in the width direction (circumferential direction). The pair of contact portions 23 and both widthwise end parts of the locking projection 22 are connected in the radial direction. The contact portion 23 is located radially outward of the locking projection 22 and located radially inward of the outer peripheral surface 11A of the peripheral wall portion 11. As shown in FIGS. 8 and 9, when the locking lance 16 is viewed in the circumferential direction, the outer surface of the contact portion 23 has a bent shape. As shown in FIG. 8, a front end 23F of the contact portion 23 is located radially inward (upper side in FIG. 8) of a rear end 23R of the contact portion 23.

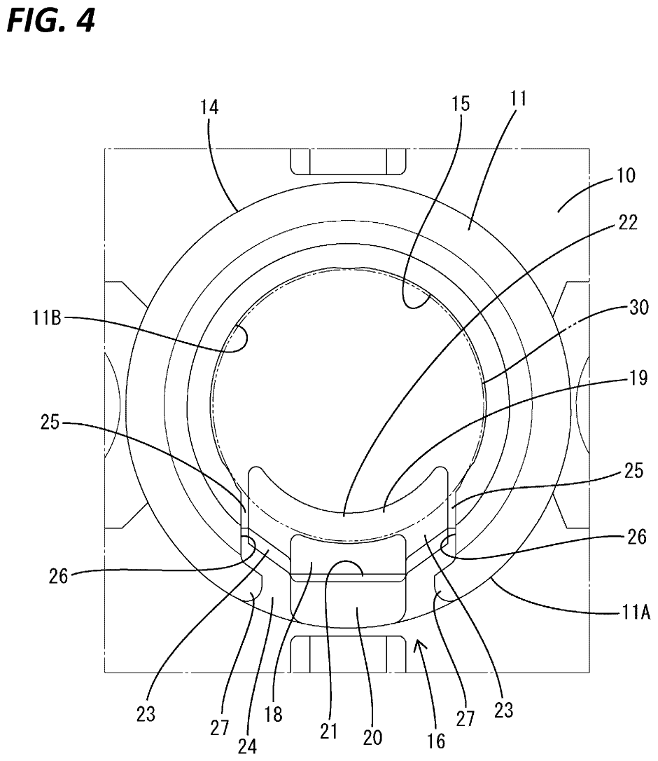

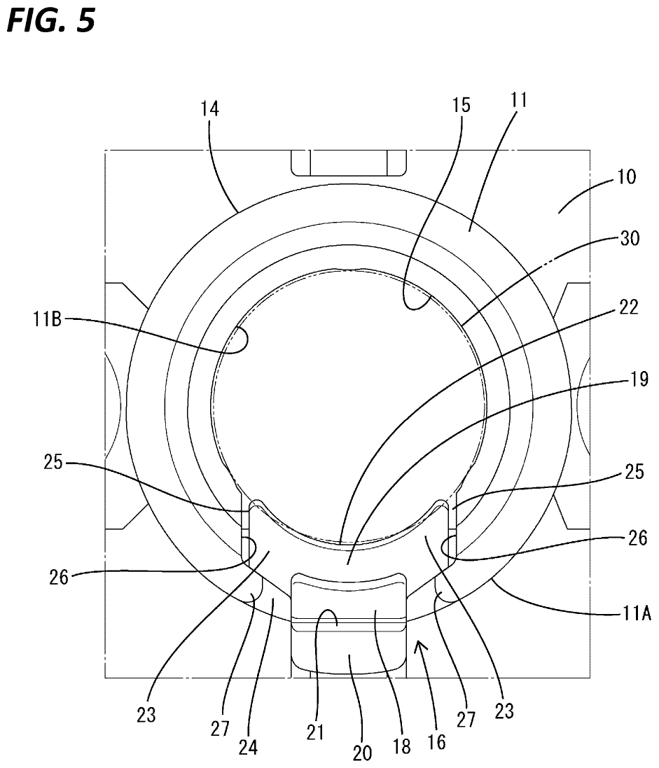

As shown in FIGS. 4 and 5, the peripheral wall portion 11 is formed with an accommodation space 24 for accommodating the locking lance 16. The accommodation space 24 includes slit-like spaces 25 disposed to sandwich the locking lance 16 from both sides in the width direction (circumferential direction). The accommodation space 24 is open in the outer peripheral surface 11A and the inner peripheral surface 11B of the peripheral wall portion 11. The front end of the accommodation space 24 communicates with the mold removal space 17. The peripheral wall portion 11 includes a pair of facing surfaces 26 facing the accommodation space 24 and facing the widthwise outer side surfaces of the locking lance 16.

The peripheral wall portion 11 is formed with a pair of excessive deflection restricting portions 27 spaced apart in the width direction (circumferential direction). The pair of excessive deflection restricting portions 27 project to approach the both outer side surfaces of the locking lance 16 in the circumferential direction from the pair of facing surfaces 26. The excessive deflection restricting portion 27 is elongated in the front-rear direction (an extension direction of the locking lance 16 from the peripheral wall portion 11) and located in the slit-like space 25. The pair of excessive deflection restricting portions 27 projecting like ribs are located radially outward of the pair of contact portions 23. The excessive deflection restricting portion 27 and the contact portion 23 are arranged side by side in the radial direction.

In a front view, a formation range in the radial direction of the excessive deflection restricting portion 27 is only in a range from the outer peripheral surface 11A of the peripheral wall portion 11 to a position outward of the inner peripheral surface 11B of the peripheral wall portion 11. That is, the excessive deflection restricting portion 27 is formed only in a thickness range in the radial direction of the peripheral wall portion 11. In a state where the locking lance 16 is not resiliently deformed, the contact portions 23 are arranged at positions separated radially inward from the excessive deflection restricting portions 27. As shown in FIG. 8, in the state where the locking lance 16 is not resiliently deformed, an interval in the radial direction between the front end 23F of the contact portion 23 and the excessive deflection restricting portion 27 is defined as a front end side interval LF and an interval in the radial direction between the rear end 23R of the contact portion 23 and the excessive deflection restricting portion 27 is defined as a rear end side interval LR. The front end side interval LF is set to be larger than the rear end side interval LR.

As shown in FIG. 9, if the locking lance 16 is resiliently deformed in a direction separating from the terminal fitting 30, the contact portions 23 approach the excessive deflection restricting portions 27. If the contact portions 23 butt against the excessive deflection restricting portions 27, any further resilient deformation of the locking lance 16 is restricted. At this time, the front end 23F and the rear end 23R of the contact portion 23 butt against the excessive deflection restricting portion 27. The pair of contact portions 23 and the pair of excessive deflection restricting portions 27 are parts having a function of keeping a resilient deformation amount of the locking lance 16 within a range of resilience limit when the locking lance 16 is resiliently deformed radially outward.

In the process of inserting the terminal fitting 30 into the terminal accommodation chamber 15, the terminal fitting 30 interferes with the locking projection 22, wherefore the locking lance 16 is resiliently deformed radially outward. The resilient deformation amount of the locking lance 16 at this time is such an amount that the contact portions 23 do not come into contact with the excessive deflection restricting portions 27. If the terminal fitting 30 reaches a proper insertion position in the terminal accommodation chamber 15, the locking lance 16 resiliently returns and the locking projection 22 is locked into the locking hole 31 of the terminal fitting 30. By this locking action, the terminal fitting 30 is retained.

In pulling out the terminal fitting 30 retained by the locking lance 16 rearward from the housing 10, the jig J such as a flathead screwdriver is inserted into the mold removal space 17 from the front of the housing 10 and a tip part of the jig J is brought into contact with the jig contact surface 21. Then, as shown in FIG. 9, the locking lance 16 is resiliently deformed radially outward (releasing direction) by the tip part of the jig J. Since the locking projection 22 is disengaged from the locking hole 31 by the resilient deformation of the locking lance 16, the retaining function by the locking lance 16 is released. Thereafter, if the coaxial cable 32 is pulled, the terminal fitting 30 can be pulled out from the terminal accommodation chamber 15.

If the resilient deformation amount of the locking lance 16 increases more than necessary when the locking lance 16 is resiliently deformed in the releasing direction by the jig J, the pair of contact portions 23 butt against the pair of excessive deflection restricting portions 27. If the contact portions 23 butt against the excessive deflection restricting portions 27, any further resilient deformation of the locking lance 16 is restricted. Since the resilient deformation amount of the locking lance 16 at this time is within the range of resilience limit of the locking lance 16, the locking lance 16 is not plastically deformed. Thus, if the jig J is separated from the locking lance 16, the locking lance 16 resiliently returns to a position where the terminal fitting 30 can be retained by the locking lance 16.

The connector of this embodiment is provided with the housing 10 including the terminal accommodation chamber 15, the terminal fitting 30, the locking lance 16 and the excessive deflection restricting portions 27. The terminal fitting 30 is inserted into the terminal accommodation chamber 15 from behind the housing 10. The locking lance 16 is formed in the peripheral wall portion 11 constituting the terminal accommodation chamber 15 and has a function of retaining the terminal fitting 30. The excessive deflection restricting portions 27 have a function of keeping a deflection amount of the locking lance 16 within a certain range when the locking lance 16 is resiliently deformed in the direction separating from the terminal fitting 30.

The locking lance 16 is arranged in a state exposed on the inner peripheral surface 11B and the outer peripheral surface 11A of the peripheral wall portion 11. The excessive deflection restricting portions 27 are arranged only within a thickness range of the peripheral wall portion 11. The connector of this embodiment can be reduced in size as compared to the case where the excessive deflection restricting portions 27 are arranged to cover the peripheral wall portion 11.

The locking lance 16 includes the narrow portion 18 and the wide portion 19 having a larger width than the narrow portion 18. The locking lance 16 is shaped by connecting the narrow portion 18 and the wide portion 19 in a deflection direction of the locking lance 16 (radial direction). Parts of the wide portion 19 projecting in the width direction (circumferential direction) from the narrow portion 18 function as the contact portions 23. The contact portions 23 have a function of restricting excessive deflection of the locking lance 16 by butting against the excessive deflection restricting portions 27. Since a thickness of the locking lance 16 is large in a region of the locking lance 16 where the wide portion 19 and the narrow portion 18 are arranged, the rigidity of the locking lance 16 is high. Therefore, the locking lance 16 of this embodiment is excellent in the reliability of the function of retaining the terminal fitting 30 as compared to a thin locking lance constituted only by the wide portion.

The wide portion 19 has a function as the locking projection 22 for retaining and locking the terminal fitting 30. In the connector of this embodiment, the shape of the locking lance 16 can be simplified as compared to the case where the locking projection 22 and the contact portions 23 are formed as different parts.

The posture of the locking lance 16 is inclined with the rear end of the locking lance 16 as a fulcrum when the locking lance 16 is resiliently deformed in the direction separating from the terminal fitting 30. In a free state where the locking lance 16 is not resiliently deformed, the interval (front end side interval LF) between the front end 23F of the contact portion 23 and the excessive deflection restricting portion 27 is set to be larger than the interval (rear end side interval LR) between the rear end 23R of the contact portion 23 and the excessive deflection restricting portion 27. According to this configuration, a large resilient deformation amount of the locking lance 16 can be ensured when the locking lance 16 is resiliently deformed in the direction separating from the terminal fitting 30. In this way, a holding force by the locking lance 16 can be enhanced by increasing a locking margin of the locking lance 16 with the terminal fitting 30.

In a front view of the locking lance 16, the peripheral wall portion 11 has a hollow cylindrical shape. The wide portion 19 (locking projection 22) has an arcuate front view shape. The narrow portion 18 is formed with the jig contact portion 20, to which the jig J for disengaging the locking lance 16 from the terminal fitting 30 is hooked. The jig contact portion 20 is formed with the jig contact surface 21 in the form of a straight flat surface in the front view. According to this configuration, when the jig J is hooked to the jig contact portion 20, the orientation and position of the jig J are stabilized. Thus, an operation of resiliently deforming the locking lance 16 is easily performed.

The sealing ring 33 is arranged at a position separated rearward from the rear end of the locking lance 16 on the outer peripheral surface 11A of the peripheral wall portion 11. According to this configuration, a size reduction can be achieved as compared to the case where the sealing ring 33 is arranged on the outer peripheral surface of a wall portion formed on an outer peripheral side of the peripheral wall portion 11.

### Other Embodiments

The present invention is not limited to the above described and illustrated embodiment, but is represented by claims. The present invention is intended to include all changes in the scope of claims and in the meaning and scope of equivalents and also include the following embodiments.

The locking lance may have a flat shape without including the narrow portion.

The locking projection to be locked to the terminal fitting may be arranged in a part different from the wide portion.

The locking projection and the contact portions may be arranged at positions different in the front-rear direction.

The jig contact portion may have a curved shape.

The terminal fitting may be a terminal fitting of a non-shield type, instead of the shield terminal including the inner conductor, the dielectric and the outer conductor.

Cross-sectional shapes of the terminal accommodation chamber and the terminal fitting are not limited to circular shapes and may be rectangular shapes.

The sealing ring may be arranged on the outer peripheral surface of a wall portion formed on an outer peripheral side of the peripheral wall portion.

### LIST OF REFERENCE NUMERALS

10 . . . housing
11 . . . peripheral wall portion
11A . . . outer peripheral surface of peripheral wall portion
11B . . . inner peripheral surface of peripheral wall portion
12 . . . tubular fitting portion
13 . . . supporting portion
14 . . . sealing surface
15 . . . terminal accommodation chamber
16 . . . locking lance
17 . . . mold removal space
18 . . . narrow portion
19 . . . wide portion
20 . . . jig contact portion
21 . . . jig contact surface
22 . . . locking projection
23 . . . contact portion
23F . . . front end of contact portion
23R . . . rear end of contact portion
24 . . . accommodation space
25 . . . slit-like space
26 . . . facing surface
27 . . . excessive deflection restricting portion
30 . . . terminal fitting
31 . . . locking hole
32 . . . coaxial cable
33 . . . sealing ring
J . . . jig
LF . . . front end side interval (interval between front end of contact portion and excessive deflection restricting portion)
LR . . . rear end side interval (interval between rear end of contact portion and excessive deflection restricting portion)

1. A connector, comprising:
a housing including a terminal accommodation chamber;
a terminal fitting to be inserted into the terminal accommodation chamber from behind the housing;
a locking lance formed in a peripheral wall portion constituting the terminal accommodation chamber, the locking lance retaining the terminal fitting; and
an excessive deflection restricting portion for keeping a deflection amount of the locking lance within a certain range when the locking lance is resiliently deformed in a direction separating from the terminal fitting,
the locking lance being arranged in a state exposed on an inner peripheral surface and an outer peripheral surface of the peripheral wall portion,
the excessive deflection restricting portion being arranged within a thickness range of the peripheral wall portion,
the locking lance being shaped such that a narrow portion and a wide portion having a larger width than the narrow portion are connected in a deflection direction of the locking lance,
the narrow potion projecting further forward than the wire portion,
a part of the wide portion projecting in a width direction from the narrow portion having a function as a contact portion for restricting excessive deflection of the locking lance by butting against the excessive deflection restricting portion,
the narrow portion being formed with a jig contact portion, and
the jig contact portion having a smaller width than the wide portion.

2. (canceled)

3. The connector of claim 1, wherein the wide portion has a function as a locking projection for retaining and locking the terminal fitting.

4. The connector of claim 1, wherein:
a posture of the locking lance is inclined with a rear end of the locking lance as a fulcrum when the locking lance is resiliently deformed in the direction separating from the terminal fitting, and
an interval between a front end of the contact portion and the excessive deflection restricting portion is set to be larger than an interval between a rear end of the contact portion and the excessive deflection restricting portion in a free state where the locking lance is not resiliently deformed.

5. The connector of claim 1, wherein:
the peripheral wall portion has a hollow cylindrical shape in a front view of the locking lance,
the wide portion has an arcuate shape in the front view, and
the narrow portion is formed with the straight jig contact portion.

6. The connector of claim 1, wherein a sealing ring is arranged at a position separated rearward from a rear end of the locking lance on the outer peripheral surface of the peripheral wall portion.
